(19) United States
(12) Patent Application Publication
(10) Pub. No.: US 2022/0055117 A1
(43) Pub. Date: Feb. 24, 2022

(54) Coating For Cutting Implement

(71) Applicant: ACME UNITED CORPORATION, FAIRFIELD, CT (US)

(72) Inventors: Dheeraj Garg, Shenzhen (CN); Richard S. Constantine, Monroe, CT (US)

(73) Assignee: ACME UNITED CORPORATION, FAIRFIELD, CT (US)

(21) Appl. No.: 17/137,491

(22) Filed: Dec. 30, 2020

Related U.S. Application Data
(63) Continuation-in-part of application No. 16/997,523, filed on Aug. 19, 2020.

(51) Int. Cl. B23B 27/14; B23K 26/34; C23C 24/10; C23C 14/02; C23C 14/06

(52) U.S. Cl. CPC B23B 27/148; B23K 26/34; B22F 3/225; C23C 14/028; C23C 14/06; C23C 24/103

(57) ABSTRACT

A cutting implement including a metal substrate, carbide edge(s), and coating is provided. The coating is zirconium PVD (ZrCRTiNO), which provides protection against corrosion of the metal substrate. In some instances, the zirconium PVD provides protection from corrosion for at least 200 hours. A layer of carbide can be added to one or more cutting edges of the metal substrate prior to the deposition of the coating. The carbide increases the sharpness of the cutting edges and therefore increases the life or longevity of the cutting edges. Thus, a combination of zirconium PVD (ZrCRTiNO) as a coating and carbide edges on a metal substrate can increase the life of the metal substrate by providing increased hardness, sharpness, and anti-corrosive properties.

### CROSS REFERENCE To RELATED APPLICATIONS

The present application is a continuation-in-part of U.S. patent application Ser. No. 16/997,523, filed on Aug. 19, 2020, the entire disclosure of which is incorporated herein by reference.

### BACKGROUND OF THE INVENTION

### 1. Field of the Invention

The present invention relates to cutting implements and, more particularly, to a coating for cutting implements.

### 2. Description of Related Art

Substantial effort has been expanded in improving the construction and operation of cutting implements for fishing, hunting, camping, and other outdoor uses. Ever increasing demands have been placed on manufacturers of these products to increase the ease of use, the wear resistance, corrosion resistance, and the ease in which the products can be cleaned, while maintaining a competitive price. For example, typical outdoor shears/knives have been unable to achieve a long-lasting cutting edge, which withstands the wide variety of products being cut and resists rust, at a competitive price.

Therefore, there is a need for continued improvements in cutting implements for outdoor use.

Description of the Related Art Section Disclaimer: To the extent that specific patents/publications/products are discussed above in this Description of the Related Art Section or elsewhere in this disclosure, these discussions should not be taken as an admission that the discussed patents/publications/products are prior art for patent law purposes. For example, some or all of the discussed patents/publications/products may not be sufficiently early in time, may not reflect subject matter developed early enough in time and/or may not be sufficiently enabling so as to amount to prior art for patent law purposes. To the extent that specific patents/publications/products are discussed above in this Description of the Related Art Section and/or throughout the application, the descriptions/disclosures of which are all hereby incorporated by reference into this document in their respective entirety(ies).

### BRIEF SUMMARY OF THE INVENTION

It is an object of the present invention to provide a cutting implement having a metal substrate, carbide edge(s), and coating.

It is a further object of the present invention to provide a cutting implement having a coating that provides one or more of improved wear resistance, improved corrosion resistance, increased hardness, pleasing appearance, reduced user effort, and increased stain resistance, and carbide edge(s) that increases the sharpness and life of the cutting edges of the cutting implement.

These and other objects of the present invention are provided by a cutting implement comprising a metal substrate, carbide edge(s), and coating. The coating on the metal substrate comprises zirconium PVD (ZrCrTiNO). The coating is preferably clear (i.e., transparent). The metal substrate has one or more cutting edges with carbide deposited thereon.

According to some aspects, the coating is ZrCRTiNO composed of 30-80 zirconium (Zr), 5-50 chromium (Cr), and 5-50 titanium (Ti).

According to some aspects, the metal substrate is any polished metal, such as stainless steel having a grade of 4116 or 420J2.

According to some aspects, the carbide has a thickness of 0.05 to 3 mm and a width of 1 to 3 mm.

According to some aspects, the carbide is deposited on one or more cutting edges of the metal substrate via a laser classing or laser welding process.

According to some aspects, the carbide is deposited on one or more cutting edges of the metal substrate via powder injection.

These and other aspects of the invention will be apparent from and elucidated with reference to the embodiment(s) described hereinafter.

The above-described and other features and advantages of the present invention will be appreciated and understood by those skilled in the art from the following detailed description, drawings, and appended claims.

### BRIEF DESCRIPTION OF THE SEVERAL VIEWS OF THE DRAWING(S)

The present invention will be more fully understood and appreciated by reading the following Detailed Description in conjunction with the accompanying drawings. The accompanying drawings illustrate only typical embodiments of the disclosed subject matter and are therefore not to be considered limiting of its scope, for the disclosed subject matter may admit to other equally effective embodiments. Reference is now made briefly to the accompanying drawings, in which:

FIG. 1 is side views of an exemplary embodiment of a pair of shears;

FIG. 2 is side views of an exemplary embodiment of snips;

FIG. 3 is perspective and side views of an exemplary embodiment of a boning curved knife;

FIG. 4 is perspective and side views of an exemplary embodiment of a bait straight knife;

FIG. 5 is perspective and side views of an exemplary embodiment of a filet flex knife;

FIG. 6A is a side view of an exemplary embodiment of a butcher knife;

FIG. 6B is a side view of an exemplary embodiment of an offset serrated knife;

FIG. 6C is a side view of an exemplary embodiment of a serrated knife;

FIG. 6D is a side view of an exemplary embodiment of a net knife;

FIG. 6E is a side view of an exemplary embodiment of a wide filet knife;

FIG. 6F is a side view of an exemplary embodiment of a butcher knife;

FIG. 6G is a side view of an exemplary embodiment of a filet knife gutting spoon;

FIG. 6H is a side view of an exemplary embodiment of a wide filet knife;

FIG. 6I is a side view of an exemplary embodiment of a freshwater fillet knife;

FIG. 6J is a side view of an exemplary embodiment of a curved blade knife;

FIG. 7 is perspective views of an exemplary embodiment of a fixed blade knife;

FIG. 8 is perspective views of an exemplary embodiment of a folding blade knife;

FIG. 9 is perspective views of an exemplary embodiment of a hacking knife;

FIG. 10A is perspective views of an exemplary embodiment of a hatchet in a first configuration;

FIG. 10B is perspective views of the hatchet of FIG. 10A in a second configuration; and

FIG. 11 is perspective views of an exemplary embodiment of a machete.

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

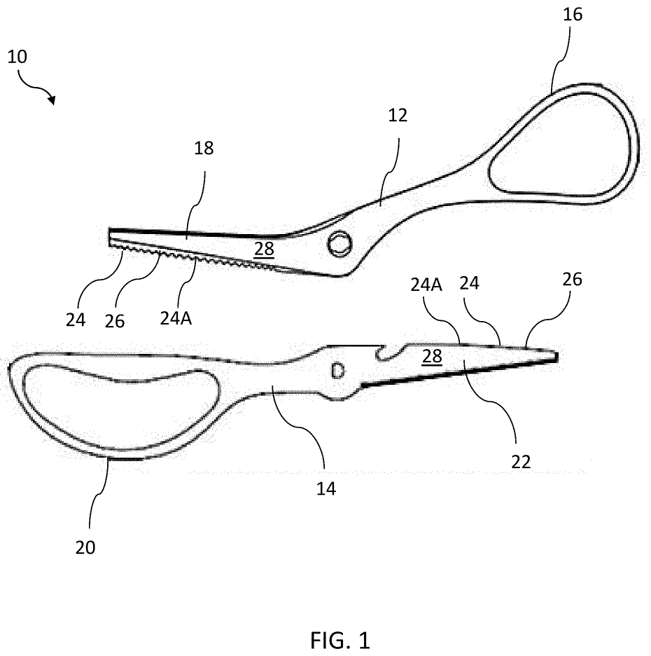

Referring now to the figures, wherein like reference numerals refer to like parts throughout, FIG. 1 shows a cutting implement in the form of a pair of shears (e.g., marine shears) generally indicated by reference numeral 10 is illustrated.

Shears 10 have a first half 12 pivotally connected to a second half 14 (note, the shears 10 in FIG. 1 show the first and second halves 12, 14 separated for clarity). First and second halves 12, 14 are pivotally connected by conventional connection means, such as a screw and a post (not shown). First half 12 can have a first handle 16 and a first blade 18. Similarly, second half 14 can have a second handle 20 and a second blade 22. In FIG. 1, each half 12, 14 has a unitary handle and blade portion. Each blade 18, 22 has a cutting edge 24. Preferably, cutting edge 24 is formed by way of a bevel 26 disposed on each blade 18, 22, respectively, Thus, shears 10 provide a pair of complementary cutting blades 18, 22 for fishing and outdoor products.

In the embodiment of shears 10 shown in FIG. 1, shears 10 is moved to an open position by moving first handle 16 and second handle 20 away from each other, separating first blade 18 and second blade 20. An object (not shown) is placed between first blade 18 and second blade 20 and then, first and second handles 16, 20 are moved back toward each other. The cutting action is performed by cutting edges 24 on first blade 18 and second blade 22.

Blades 18, 22 are composed of a polished metal substrate. Preferably, blades 18, 22 are made of steel, more preferably stainless steel, such as stainless steel 4116 or 420J2. In addition, blades 18, 22 can be heat-treated to further increase the hardness of the blades. Shears 10 further include a coating 28 disposed on each blade 18, 22. Coating 28 provides cutting edges 24 with extremely tough, hard, wear resistant characteristics. The increased hardness of cutting edges 24 provides shears 10 with substantially increased longevity, while also providing the scissors with corrosion resistance, as well as providing a smooth and uniform appearance and color.

In some embodiments, coating 28 provides shears 10 with an aesthetically acceptable color or appearance and in some instances, coating 28 differentiates blades 18, 22 having coating 28 from uncoated blades. Coating 28 also increases the ease of use of shears 10 by providing blades 18, 22 with a smooth surface finish, which reduces friction between blades 18, 22 during use. Thus, blades 18, 22 have less friction between the two inside blade faces, which provides a smoother cutting action and less cutting effort than in coated blades without coating 28.

Coating 28 is zirconium PVD (ZrCrTiNO). Coating 28 is used to coat a polished substrate and, more particularly, a polished metal substrate (e.g., stainless steel grade 4116 or 420J2). In FIG. 1, coating 28 is disposed on blades 18, 22 such that the coating forms a metallurgical bond with the blades, which resists flaking, blistering, chipping, and peeling. In fact, coating 28 is adsorbed into the surface layer of the metal of blades 18, 22. Coating 28 is disposed on blades 18, 22 with a thickness in a range between about 0.2 and 0.5 microns, more preferably about 0.4 microns.

In an embodiment, coating 28 is a clear (i.e., transparent), protective coating having the formula ZrCrTiNO, where Zr=30-80, Cr=5-50 and Ti=5-50. The zirconium PVD (ZrCrTiNO) coating 28 can be disposed on blades 18, 22 according to methods such as plasma enriched physical vapor deposition processes. The thickness of the zirconium PVD (ZrCrTiNO) coating 28 is within the range of 0.2 and 0.5 microns, as stated above. For steel blades 22, 26 (or any other steel cutting implement (4116 or 420J2)), the zirconium PVD (ZrCrTiNO) coating 28 provides protection from corrosion for a minimum of 200 hours. The 200-hour minimum has been determined through exposure of the zirconium PVD (ZrCrTiNO) coating 28 on blades 18, 22 (or any other steel cutting implement (4116 or 420J2)) to an ASTM-B117 Salt fog test.

In an alternative embodiment, coating 28 is combined with a carbide edge 24A on blades 18, 22. Carbide edge 24A increases the sharpness and longevity of blades 18, 22. Preferably, a carbide edge 24A is applied to blades 18, 22 prior to coating 28. According to an embodiment, carbide edges 24A are composed of cutting edges 24 on first blade 18 and second blade 22. Carbide edge 24A can be added to cutting edges 24 on blades 18, 22 via a variety of methods.

According to one embodiment, cutting edges 24 is deposited with a material or mixture of materials (i.e., carbide) through a laser cladding or laser welding process. In one embodiment, the material or mixture is deposited via powder injection. In another embodiment, the material or mixture is pre-placed powder on the substrate or by wire feeding. Among the methods discussed above, laser cladding by powder injection is most effective. During this process, a laser beam melts the powder (material or mixture) particles and deposits on cutting edges 24 of blades 18, 22, forming a permanent layer (i.e., carbide edge 24A). According to an embodiment, the permanent layer comprising carbide edge 24A has a thickness of 0.05 to 3 mm and a width of 1 to 3 mm. Carbide edge 24A increases the sharpness and life of cutting edge 24 of blades 18, 22.

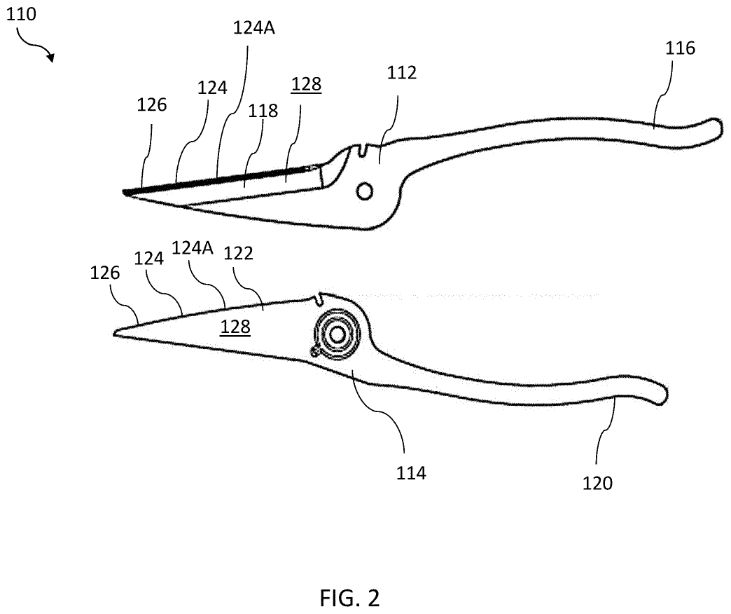

It should also be recognized that coating 28 and carbide edge 24A have been described above by way of example only as finding use with a cutting implement in the form of shears 10. Of course, coating 28 and carbide edge 24A can provide the aforementioned benefits to other cutting implements or polished metal substrates. Such cutting implements can include other scissors, knives (e.g., fishing and everyday carry), saws, snips, wire cutter, machetes, axes, hatchets, etc. Further, such cutting implements can include the aforementioned and any others used in fishing and outdoor products. FIGS. 2 to 10 illustrate alternate exemplary embodiments of cutting implements, which have coating 28 and carbide edge(s) 24A.

An exemplary embodiment of a cutting implement in the form of snips 110 is illustrated in FIG. 2. In the embodiment of snips 110 shown in FIG. 2, snips 110 has first and second halves 112, 114 pivotally connected by conventional connection means, such as a screw and a post (not shown). First half 12 has a first handle 116 and a first blade 118, while second half 14 has a second handle 120 and a second blade 122. In FIG. 2, each half 112, 114 has a unitary handle and blade portion. Each blade 118, 122 has a cutting edge 124. Preferably, cutting edge 124 is formed by way of a bevel 126 disposed on each blade 118, 122, respectively. Thus, snips 110 provide a pair of complementary cutting blades 118, 122 for fishing and outdoor products.

In the embodiment of snips 110 shown in FIG. 2, snips 110 is moved to an open position by moving first handle 116 and second handle 120 away from each other, separating first blade 118 and second blade 122. An object (not shown) is placed between first blade 118 and second blade 122 and then, first and second handles 116, 120 are moved back toward each other. The cutting action is performed by cutting edges 124 on first blade 118 and second blade 122. Cutting edges 124 have carbide deposited thereon, forming carbide edges 124A with a thickness of 0.05 to 3 mm and a width of 1 to 3 mm. Carbide edges 124A can be formed according to any of the methods described above in conjunction with carbide edges 24A in FIG. 1. Carbide edges 124A increase the sharpness of blades 118, 122 and the life of cutting edges 124.

First and second blades 118, 120 are preferably made of steel, more preferably stainless steel, such as stainless steel 420. In addition, first and second blades 118, 120 can be heat-treated to further increase the hardness. Snips 110 has a coating 128 disposed on first and second blades 118, 120. Again, coating 128 has a thickness in a range between about 0.2 microns and 0.5 microns, more preferably about 0.4 microns. Coating 128, like coating 28, provides first and second blades 118, 120 with extremely tough, hard, wear resistant characteristics. This increased hardness provides snips 110 with substantially increased longevity, while also providing the trimmer with corrosion resistance, as well as providing a smooth and uniform appearance and color. Coating 128 can be composed of the formula described above with reference to coating 28.

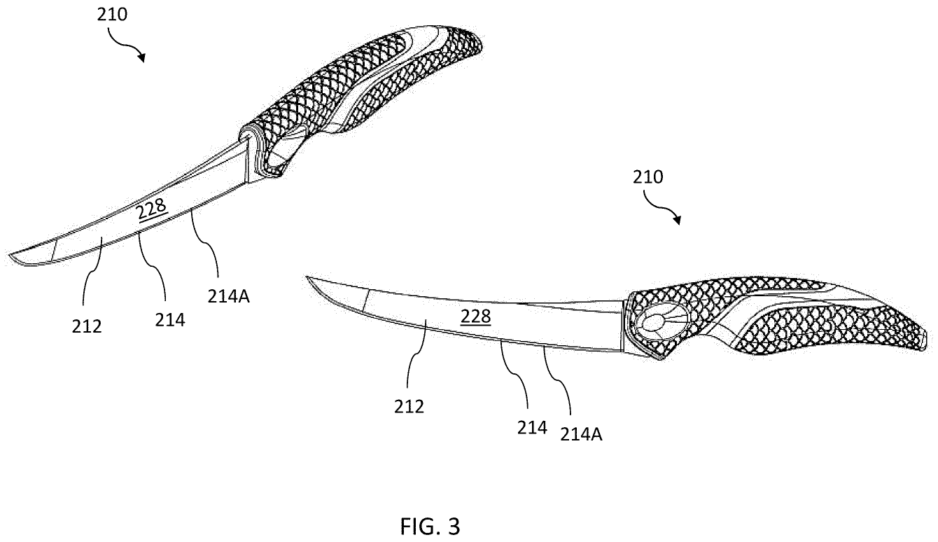

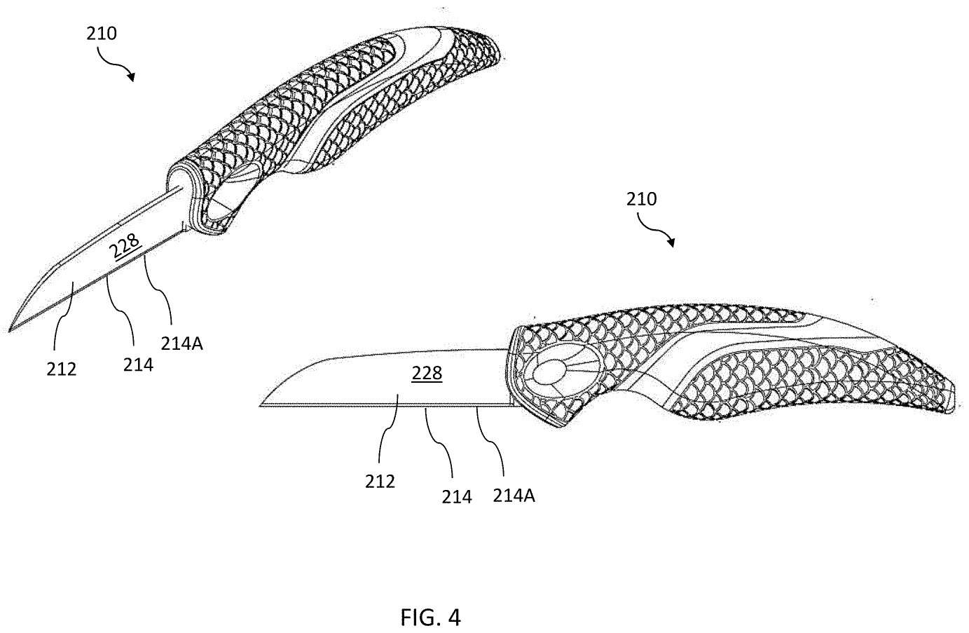

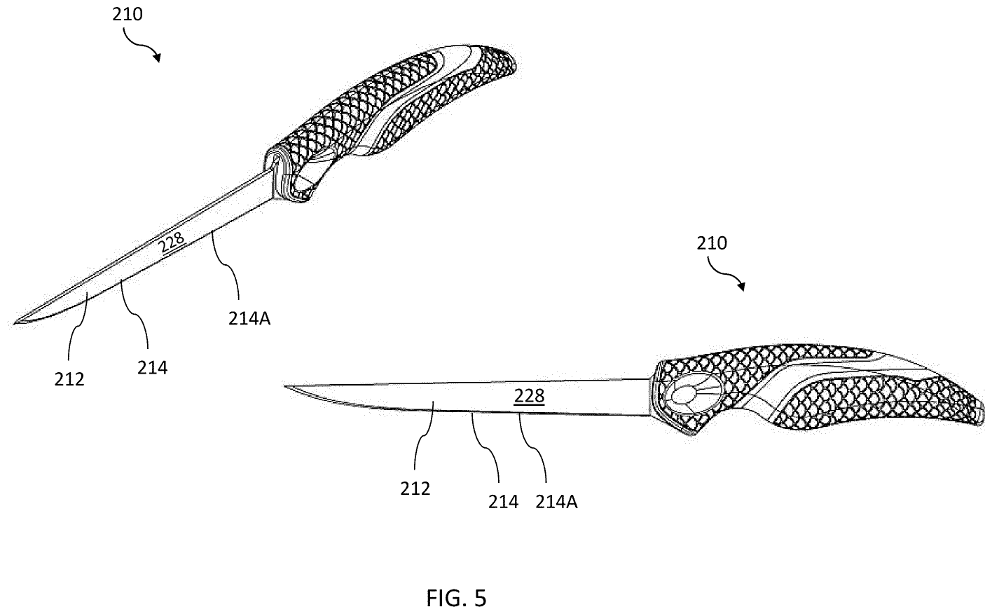

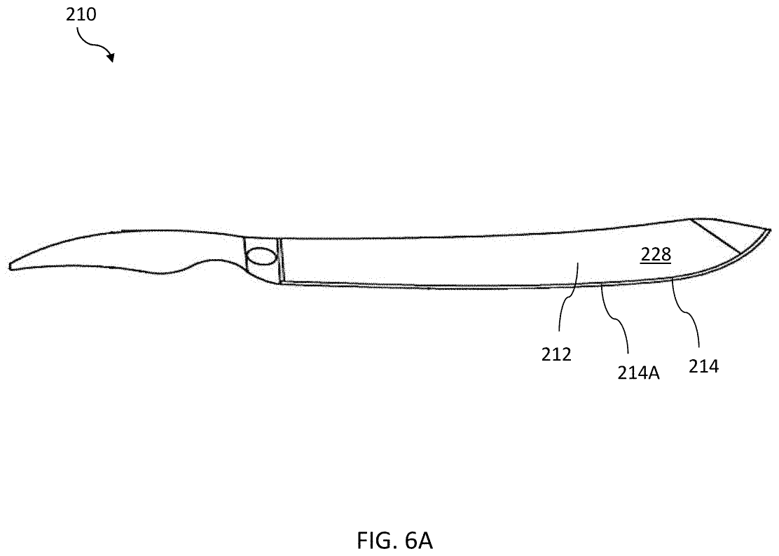

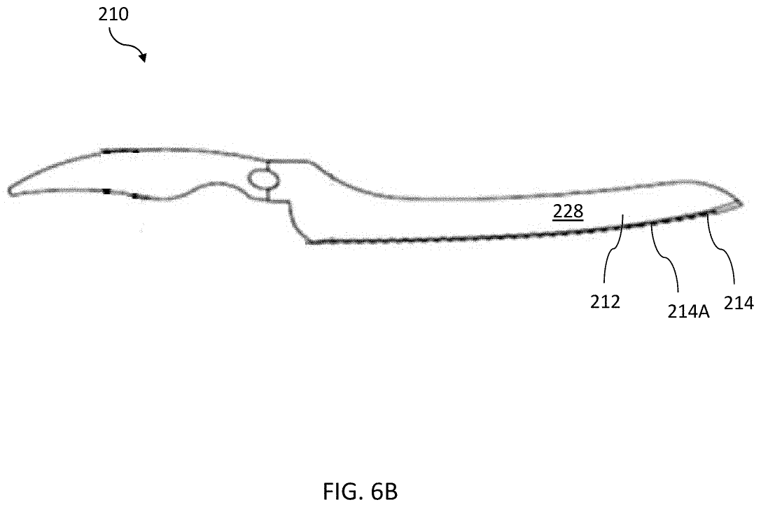

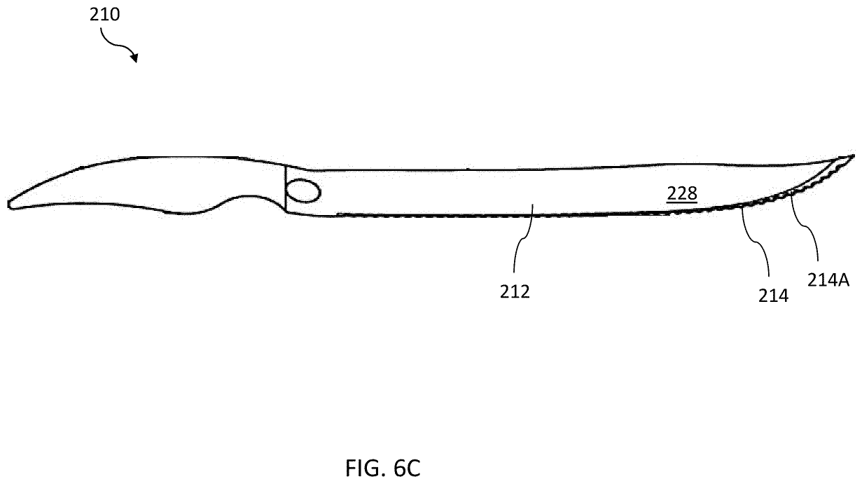

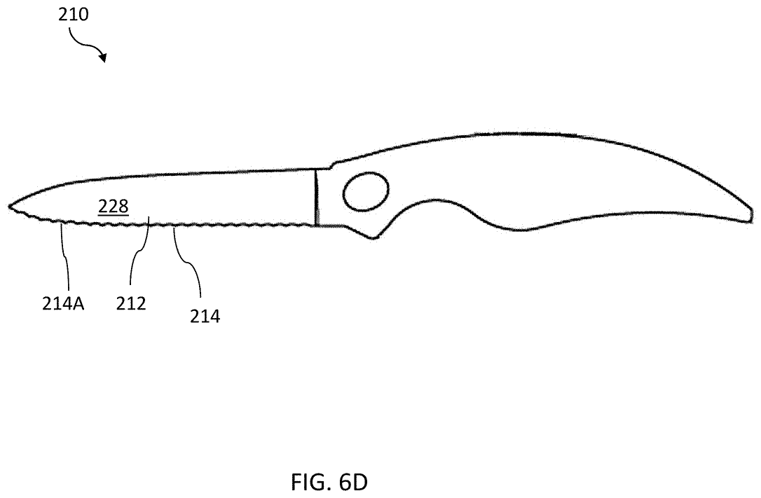

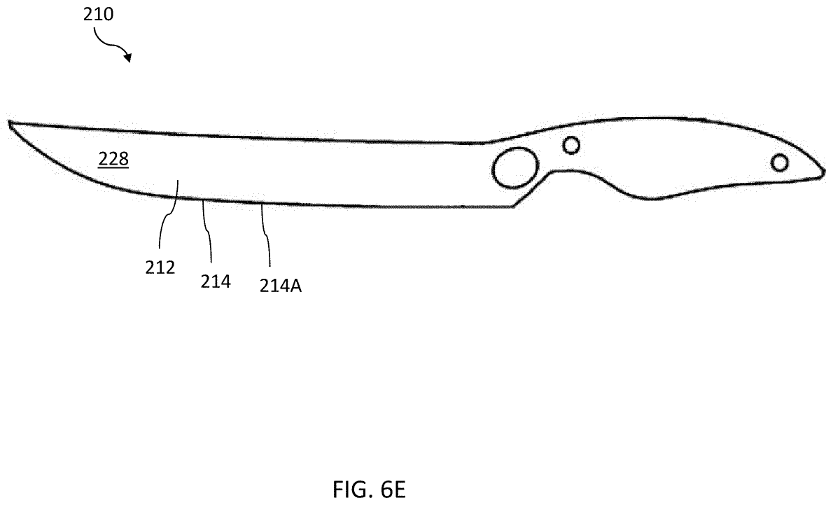

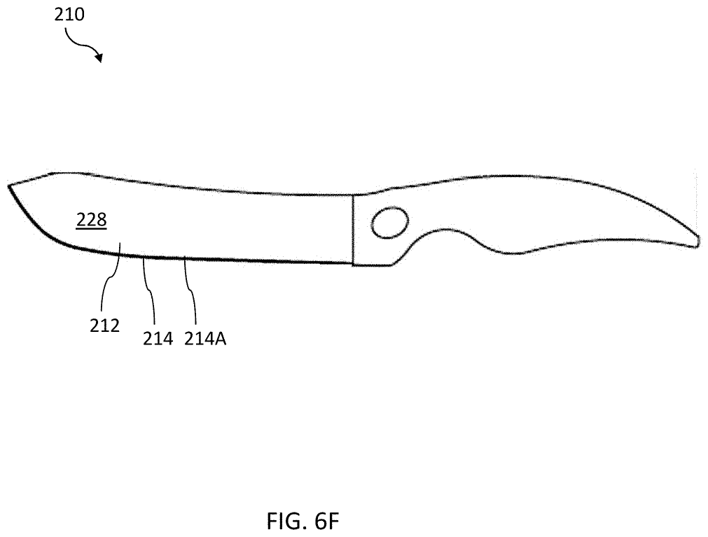

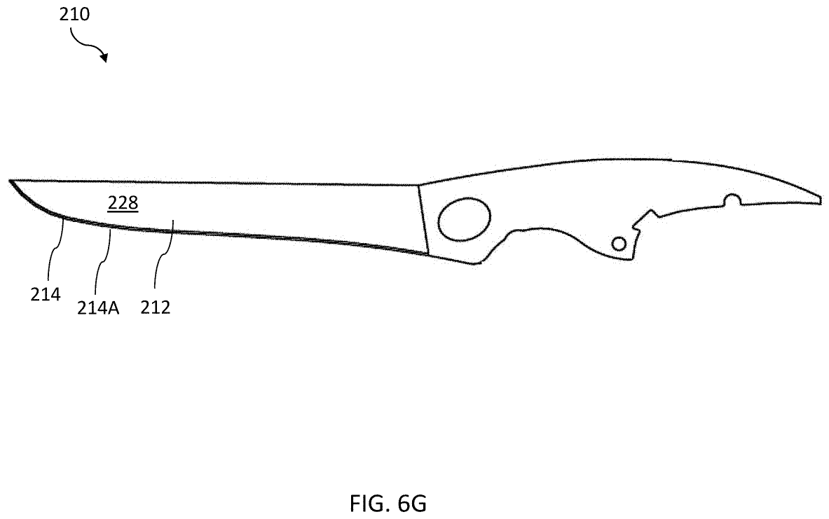

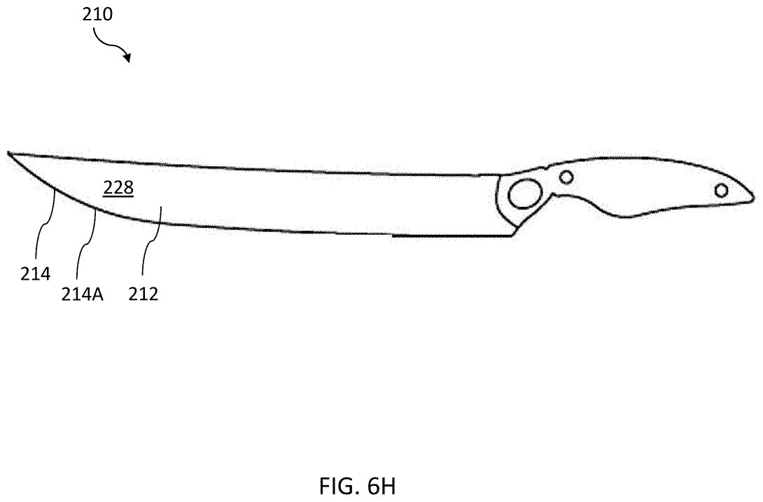

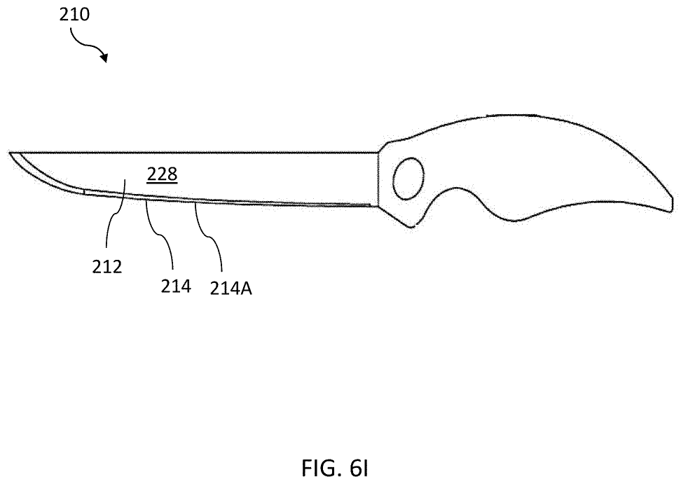

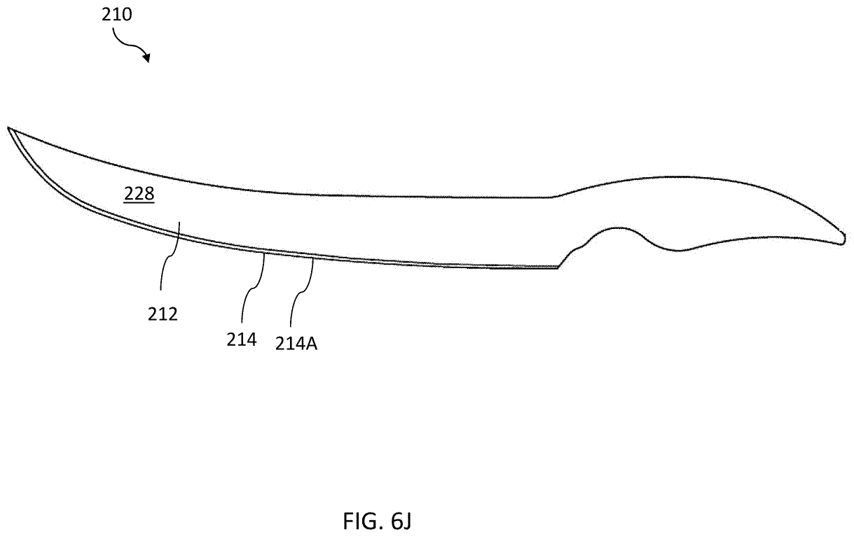

An exemplary embodiment of a cutting implement in the form of a knife 210 is illustrated in FIGS. 3-6J. Knife 210 is a boning curved knife in FIG. 3, a bait straight knife in FIG. 4, and a filet flex knife in FIG. 5. However, the cutting implement can be any type of knife, such as a butcher knife (FIGS. 6A and 6F), an offset serrated knife (FIG. 6B), a serrated knife (FIG. 6C), a net knife (FIG. 6D)), a wide filet knife (FIGS, 6E and 6H), a filet knife gutting spoon (FIG. 6G), a freshwater fillet knife, (FIG. 6I), and a curved blade knife (FIG. 6J).

Knife 210 includes a blade 212 with a sharpened peripheral edge 214. In an embodiment, blade 212 is composed of a rugged steel member, preferably stainless steel, such as stainless steel 420. In addition, blade 212 can be heat-treated to further increase the hardness. In all of the embodiments of knife 210 in FIGS. 3-6J, peripheral edge 214 can have carbide deposited thereon, forming a carbide edge 214A with a thickness of 0.05 to 3 mm and a width of 1 to 3 mm. Carbide edge 214A can be formed according to any of the methods described above in conjunction with carbide edges 24A in FIG. 1. Carbide edge 214A increases the sharpness of blade 212 and the life of peripheral edge 214.

In all of the embodiments of knife 210 in FIGS. 3-6J, knife 210 has a coating 228 disposed on blade 212. Coating 228 can be composed of the formula described above with reference to coating 28. As described in detail above with respect to the exemplary embodiment of FIG. 1, coating 228 has a thickness in a range between about 0.2 microns and 0.5 microns, more preferably about 0.4 microns. Coating 228 provides blade 212 with extremely tough, hard, wear resistant characteristics. This increased hardness provides knife 210 with substantially increased longevity, while also providing the trimmer with corrosion resistance, as well as providing a smooth and uniform appearance and color.

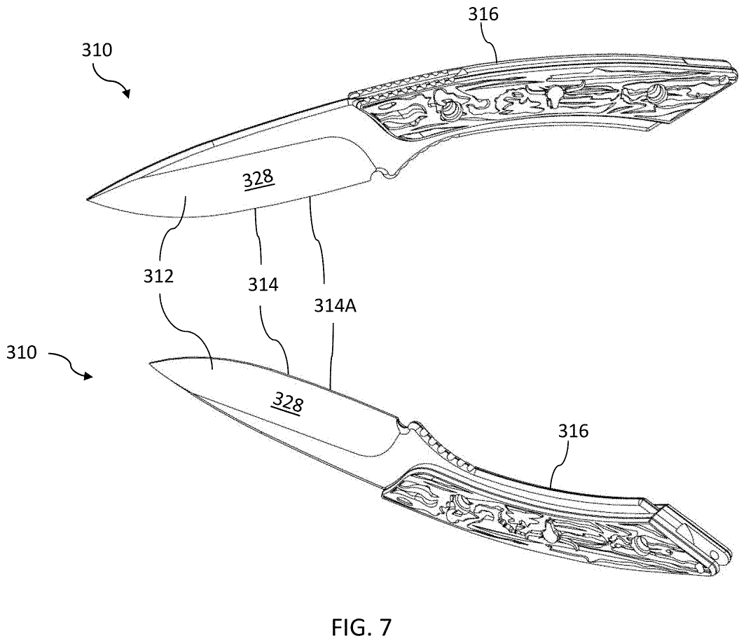

An exemplary embodiment of a cutting implement in the form of a fixed blade knife 310 is illustrated in FIG. 7. Fixed blade knife 310 includes a blade 312 with a sharpened peripheral edge 314, blade 312 extending from a handle 316. In an embodiment, blade 312 is composed of a rugged steel member, preferably stainless steel, such as stainless steel 420. In addition, blade 312 can be heat-treated to further increase the hardness. In the embodiment of fixed blade knife 310 in FIG. 7, peripheral edge 314 can have carbide deposited thereon, forming a carbide edge 314A with a thickness of 0.05 to 3 mm and a width of 1 to 3 mm. Carbide edge 314A can be formed according to any of the methods described above in conjunction with carbide edges 24A in FIG. 1. Carbide edge 314A increases the sharpness of blade 312 and the life of peripheral edge 314.

Fixed blade knife 310 in FIG. 7 has a coating 328 disposed on blade 312. Coating 328 can be composed of the formula described above with reference to coating 28. As described in detail above with respect to the exemplary embodiment of FIG. 1, coating 328 has a thickness in a range between about 0.2 microns and 0.5 microns, more preferably about 0.4 microns. Coating 328 provides blade 312 with extremely tough, hard, wear resistant characteristics. This increased hardness provides fixed blade knife 310 with substantially increased longevity, while also providing the trimmer with corrosion resistance, as well as providing a smooth and uniform appearance and color.

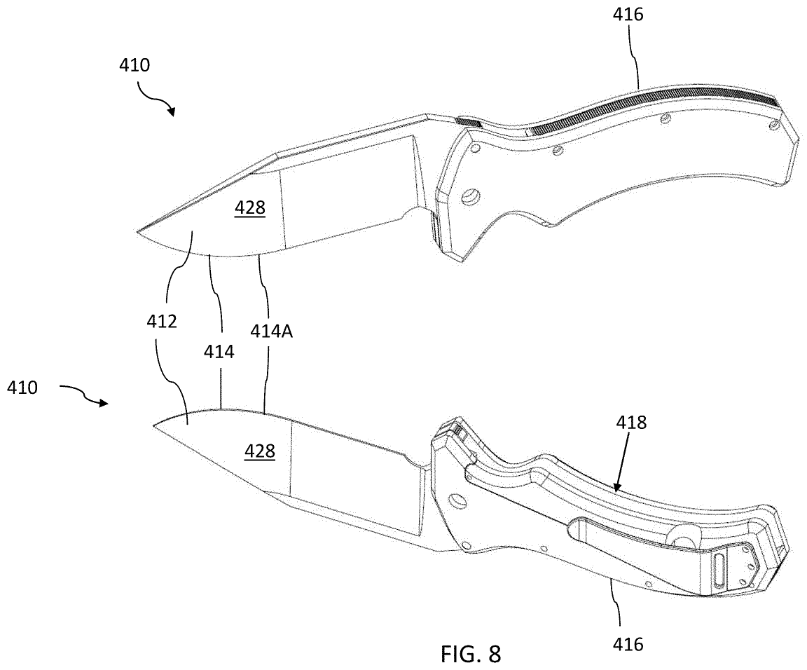

An exemplary embodiment of a cutting implement in the form of a folding blade knife 410 is illustrated in FIG. 8. Folding blade knife 410 includes a blade 412 extending from a handle 416. Specifically, blade 412 is rotatable relative to handle 416. In the embodiment shown in FIG, 8, handle 416 comprises a slot 418 sized and configured to receive at least a portion of blade 412. When blade 412 is not in use, blade 412 can be rotated into slot 418 in handle 416.

Blade 412 comprises a sharpened peripheral edge 414. In an embodiment, blade 412 is composed of a rugged steel member, preferably stainless steel, such as stainless steel 420. In addition, blade 412 can be heat-treated to further increase the hardness. In the embodiment of folding blade knife 410 in FIG. 8, peripheral edge 414 can have carbide deposited thereon, forming a carbide edge 414A with a thickness of 0.05 to 3 mm and a width of 1 to 3 mm. Carbide edge 414A can be formed according to any of the methods described above in conjunction with carbide edges 24A in FIG. 1. Carbide edge 414A increases the sharpness of blade 412 and the life of peripheral edge 414.

Folded blade knife 410 in FIG. 8 has a coating 428 disposed on blade 412, Coating 428 can be composed of the formula described above with reference to coating 28. As described in detail above with respect to the exemplary embodiment of FIG. 1, coating 428 has a thickness in a range between about 0.2 microns and 0.5 microns, more preferably about 0.4 microns. Coating 428 provides blade 412 with extremely tough, hard, wear resistant characteristics. This increased hardness provides folding blade knife 410 with substantially increased longevity, while also providing the trimmer with corrosion resistance, as well as providing a smooth and uniform appearance and color.

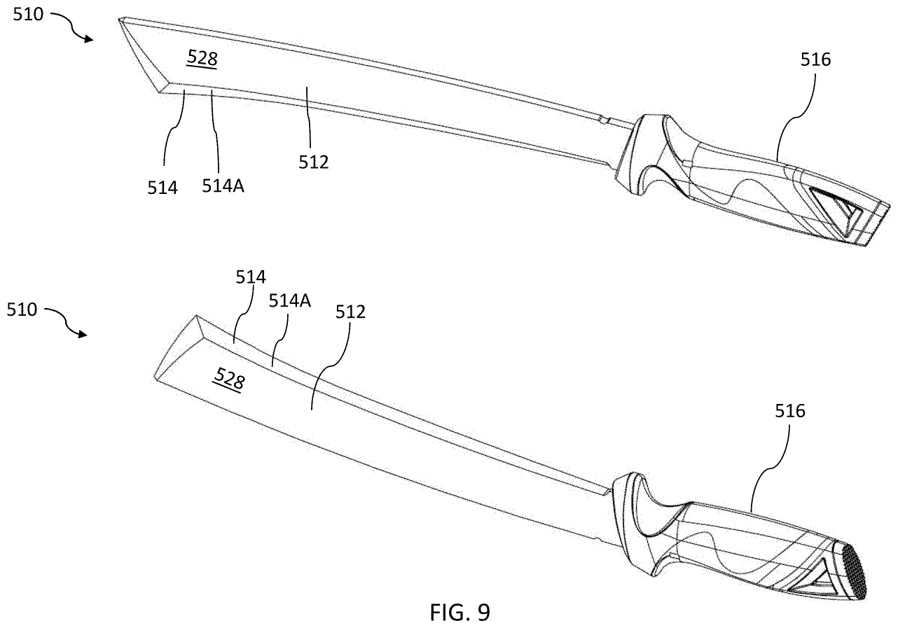

An exemplary embodiment of a cutting implement in the form of a hacking knife 510 is illustrated in FIG. 9. Hacking knife 510 includes a blade 512 with a sharpened peripheral edge 514, blade 512 extending from handle 516. In an embodiment, blade 512 is composed of a rugged steel member, preferably stainless steel, such as stainless steel 420. In addition, blade 512 can be heat-treated to further increase the hardness. In the embodiment of hacking knife 510 in FIG. 9, peripheral edge 514 can have carbide deposited thereon, forming a carbide edge 514A with a thickness of 0.05 to 3 mm and a width of 1 to 3 mm. Carbide edge 514A can be formed according to any of the methods described above in conjunction with carbide edges 24A in FIG. 1. Carbide edge 514A increases the sharpness of blade 512 and the life of peripheral edge 514.

Hacking knife 510 in FIG. 9 has a coating 528 disposed on blade 512. Coating 528 can be composed of the formula described above with reference to coating 28, As described in detail above with respect to the exemplary embodiment of FIG. 1, coating 528 has a thickness in a range between about 0.2 microns and 0.5 microns, more preferably about 0.4 microns. Coating 528 provides blade 512 with extremely tough, hard, wear resistant characteristics. This increased hardness provides hacking knife 510 with substantially increased longevity, while also providing the trimmer with corrosion resistance, as well as providing a smooth and uniform appearance and color.

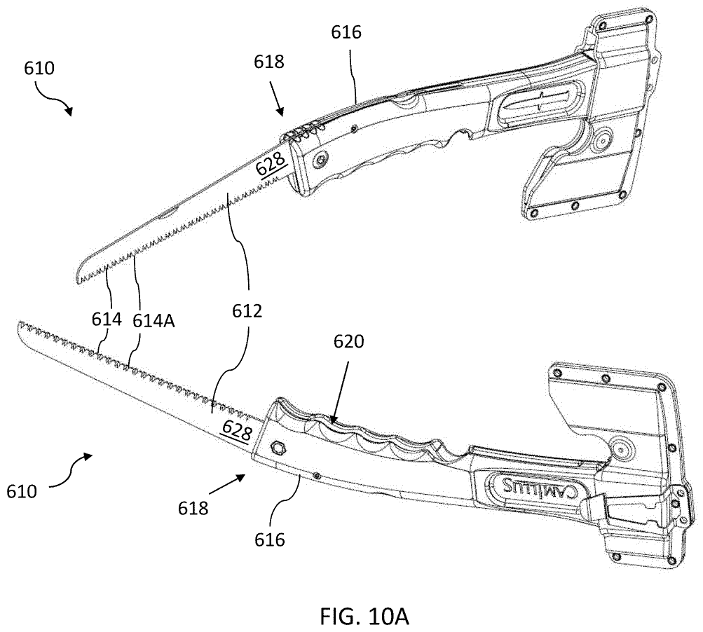

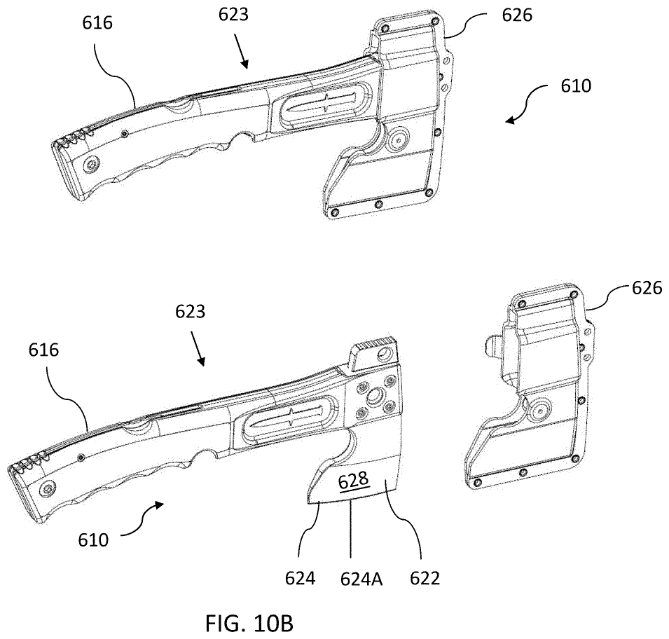

Exemplary embodiments of a cutting implement in the form of a hatchet 610 is illustrated in two different configurations in FIGS. 10A and 10B. Hatchet 610 includes a first blade 612 extending from a handle 616. Specifically, first blade 612 extends from a first end 618 of handle 616, as shown in FIG. 10A. First blade 612 is rotatable relative to handle 616. Handle 616 comprises a slot 620 sized and configured to receive at least a portion of first blade 612. When first blade 612 is not in use, it is rotated at least partially into slot 620.

A second end 623 of handle 616 is connected to a second blade 622, as shown in FIG. 10B. Second blade 622 is fixed or otherwise stationary. When second blade 622 is not in use, it is protected by a cover 626. Cover 626 allows a user to use first blade 612 (FIG. 10A) without risk of harm from second blade 622.

Both first and second blades 612, 622 have a sharpened peripheral edge 614, 624. In an embodiment, first and second blades 612, 622 are composed of a rugged steel member, preferably stainless steel, such as stainless steel 420. In addition, first and second blades 612, 622 can be heat-treated to further increase the hardness. In the embodiment of hatchet 610 in FIGS. 10A and 10B, peripheral edges 614, 624 can have carbide deposited thereon, forming carbide edges 614A, 624A with a thickness of 0.05 to 3 mm and a width of 1 to 3 mm. Carbide edges 614A, 624A can be formed according to any of the methods described above in conjunction with carbide edges 24A in FIG. 1. Carbide edges 614A, 624A increase the sharpness of first and second blades 612, 622 and the life of peripheral edges 614, 624.

Hatchet 610 in FIGS. 10A and 10B has a coating 628 disposed on first and second blades 612, 622. Coating 628 can be composed of the formula described above with reference to coating 28. As described in detail above with respect to the exemplary embodiment of FIG. 1, coating 628 has a thickness in a range between about 0.2 microns and 0.5 microns, more preferably about 0.4 microns. Coating 628 provides first and second blades 612, 622 with extremely tough, hard, wear resistant characteristics. This increased hardness provides hatchet 610 with substantially increased longevity, while also providing the trimmer with corrosion resistance, as well as providing a smooth and uniform appearance and color.

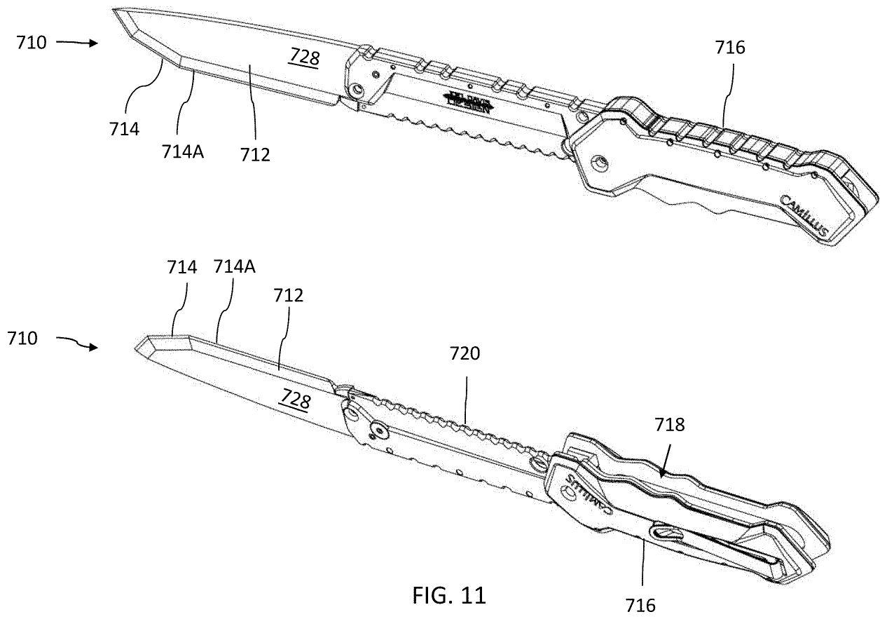

An exemplary embodiment of a cutting implement in the form of a machete 710 is illustrated in FIG. 11. Machete 710 includes a blade 712 with a sharpened peripheral edge 714. Blade 712 extends from a handle 716. In the embodiment shown in FIG. 11, an extension piece 720 connects blade 712 to handle 716. Both extension piece 720 and blade 712 are rotatable relative to handle 716. Handle 716 comprises a slot 718 sized and configured to receive at least a portion of both extension piece 720 and blade 712. When blade 712 is not in use, blade 712 is rotated toward extension piece 720 and then both extension piece 720 and blade 712 are rotated at least partially into slot 718 in handle 716.

In an embodiment, blade 712 is composed of a rugged steel member, preferably stainless steel, such as stainless steel 420. In addition, blade 712 can be heat-treated to further increase the hardness. In the embodiment of machete 710 in FIG. 11, peripheral edge 714 can have carbide deposited thereon, forming a carbide edge 714A with a thickness of 0.05 to 3 mm and a width of 1 to 3 mm. Carbide edge 714A can be formed according to any of the methods described above in conjunction with carbide edges 24A in FIG. 1. Carbide edge 714A increases the sharpness of blade 712 and the life of peripheral edge 714. Machete 710 in FIG. 11 has a coating 728 disposed on blade 712. Coating 728 can be composed of the formula described above with reference to coating 28. As described in detail above with respect to the exemplary embodiment of FIG. 1, coating 728 has a thickness in a range between about 0.2 microns and 0.5 microns, more preferably about 0.4 microns. Coating 728 provides blade 712 with extremely tough, hard, wear resistant characteristics. This increased hardness provides hacking knife 710 with substantially increased longevity, while also providing the trimmer with corrosion resistance, as well as providing a smooth and uniform appearance and color.

The coating described herein for stationery cutting implements provides a cost competitive manner to improve the hardness, longevity, stain resistance, and ease of use of the cutting implement.

It should also be noted that the terms “first”, “second’, and “third” and the like may be used herein to modify various elements. These modifiers do not imply a spatial, sequential, or hierarchical order to the modified elements unless specifically stated.

While the invention has been described with reference to one or more exemplary embodiments, it will be understood by those skilled in the art that various changes may be made and equivalents may be Substituted for elements thereof without departing from the scope of the invention. In addition, many modifications may be made to adapt a particular situation or material to the teachings of the disclosure without departing from the essential Scope thereof. Therefore, it is intended that the invention not be limited to the particular embodiment(s) disclosed as the best mode contemplated for carrying out this invention, but that the invention will include all embodiments falling within the scope of the appended claims.

What is claimed is:

1. A cutting implement, comprising:
a metal substrate having one or more cutting edges with carbide deposited thereon; and
a coating disposed on the metal substrate, wherein said coating is ZrCRTiNO composed of 30-80 zirconium (Zr), 5-50 chromium (Cr), and 5-50 titanium (Ti).

2. The cutting implement of claim 1, wherein the metal substrate is polished.

3. The cutting implement of claim 1, wherein the metal substrate is stainless steel having a grade 4116 or 420J2.

4. The cutting implement of claim 1, wherein the metal substrate is a pair of complementary cutting blades, the coating disposed on each of said pair of complementary cutting blades.

5. The cutting implement of claim 4, wherein the pair of complementary cutting blades each have one of the one or more cutting edges.

6. The cutting implement of claim 1, wherein the coating has a thickness within the range of 0.2 and 0.5 microns.

7. The cutting implement of claim 1, wherein, the coating is resistant to corrosion for at least 200 hours.

8. The cutting implement of claim 1, wherein the coating is transparent.

9. The cutting implement of claim 1, wherein the coating has a thickness of 0.2 to 0.5 microns.

10. The cutting implement of claim 1, wherein the coating is disposed on the metal substrate via plasma enriched physical vapor deposition processes.

11. The cutting implement of claim 1, wherein the carbide has a thickness of 0.05 to 3 mm.

12. The cutting implement of claim 1, wherein the carbide has a width of 1 to 3 mm.

13. The cutting implement of claim 1, wherein the carbide is deposited on the one or more cutting edges via a laser classing or laser welding, process.

14. The cutting implement of claim 1, wherein the carbide is deposited on the one or more cutting edges via powder injection.
